(19) United States
(12) Patent Application Publication
(10) Pub. No.: US 2008/0191626 A1
(43) Pub. Date: Aug. 14, 2008

(54) LIGHTING SYSTEM

(75) Inventors: Stuart Salter, White Lake, MI (US); Lynda K. Fulgenzi, Northville, MI (US); Michael Whitens, Novi, MI (US); Roger Hayden, Plymouth, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/672,707

(22) Filed: Feb. 8, 2007

(51) Int. Cl. B60Q 3/02

(52) U.S. Cl. 315/77

(57) ABSTRACT

A lighting system includes a lighting device configured to emit light having varying colors and intensities. In one embodiment, the emission of light occurs in response to pulse width modulated (PWM) signals generated by a control module. The lighting system may be programmed to emit light in accordance with user programming and various inputs.

### TECHNICAL FIELD

The embodiments described herein relate to a lighting system.

### BACKGROUND

Vehicle lighting systems typically include exterior and interior lighting. The exterior lighting may include front lamps, rear lamps, and puddle lamps that illuminate areas in the vicinity of the vehicle doors. The interior lighting typically provide ambient lighting within the vehicle for safety and convenience. Although the conventional interior and exterior lighting systems are useful, there exists a wide horizon for improvement. For instance, conventional lighting systems lack flexibility in adjusting the color and intensity of emitted light. Additionally, conventional vehicle lighting systems are not configured for customization. That is, users are unable to select specific colors of light to be emitted based on certain vehicle inputs.

The embodiments described herein were conceived in view of these and other disadvantages of conventional lighting systems.

### SUMMARY

A lighting system for a vehicle and a method of lighting the vehicle are disclosed. The lighting system includes at least one input and at least one lighting device. The lighting device is configured to emit light about at least one of an interior and exterior portions of the vehicle when energized. In one embodiment, the emitted light has varying colors. The lighting system also includes a control module that receives the one input and communicates with the lighting device. The control module may be configured to receive the input and generate pulse width modulated (PWM) signals that energize the lighting device causing the lighting device to emit light having varying colors in response to the one input.

The method of providing light includes receiving at least one input. The method also includes generating PWM signals configured to cause the lighting device to emit light having varying colors in response to the at least one input. The method further includes emitting light about at least one of the interior and exterior portions of the vehicle via the at least one lighting device, wherein the color of the emitted light varies based upon the at least one input.

### BRIEF DESCRIPTION OF THE DRAWINGS

The novel features of the described embodiments are set forth with particularity in the appended claims. These embodiments, both as to their organization and manner of operation, together with further advantages thereof, may be best understood with reference to the following description, taken in connection with the accompanying drawings in which:

FIG. 1 illustrates a vehicle having a lighting system in accordance with an embodiment of the present invention;

FIG. 2 illustrates a simplified block diagram of a lighting system in accordance with an embodiment of the present invention; and

FIG. 3 illustrates a flow chart of a method for providing lighting in accordance with an embodiment of the present invention.

### DETAILED DESCRIPTION OF THE EMBODIMENT(S)

As required, detailed descriptions of embodiments are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art.

The embodiments described herein include a lighting system that is configured to emit light having varying colors and intensities in response to certain inputs. The emission of light having preferred colors and intensities by the lighting system is also customizable by a system operator or user. It is recognized that the lighting system may be implemented on/at vehicles, buildings, or virtually any suitable location or device. Accordingly, the embodiments described in the context of a vehicle are merely exemplary and not intended to serve as a limitation to the present invention.

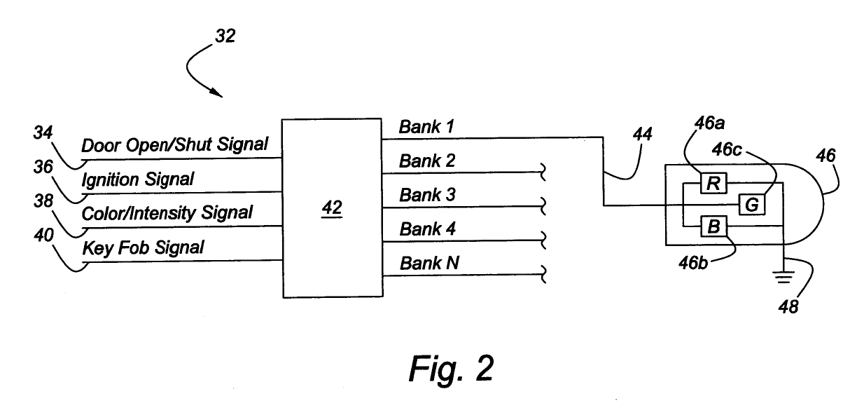

Referring to FIG. 2, a simplified block diagram of a lighting system 32 is illustrated. Lighting system 32 includes a plurality of inputs that are received by a control device 42, which generates signals for a lighting device 46. The inputs include a door input 34, an ignition input 36, a selection device input 38 and a keyless entry device input 40. Door input 34 is generated based on the position or state of a vehicle door. For example, if a vehicle door is closed, door input 34 would indicate that the vehicle door is closed. Ignition input 36 is generated in response to the position of a vehicle ignition. Selection device input 38 is generated in response to a selection device that allows customization of emitted light colors and intensities. Keyless entry device input 40 is generated in response to a keyless entry device including, but not limited to, a key fob that may unlock and lock vehicle doors and/or start a vehicle.

Control device 42, having data storage and processing capability, receives and processes the inputs. Control device 42 may be a control module, discrete controller, or any combination of devices configured to receive and process the inputs.

Selection and customization of emitted light may be carried out through the use of a selection device (e.g., a switch). In some instances, the selection device may be used for programming control device 42 to enable the emission of desired colors and intensities and lighting transitions. For example, when the user is not within the vicinity of lighting system 32 as indicated by ignition input 36 or door input 34, control device 42 may be programmed to not cause energization of lighting device 46. In response to the received and processed inputs, control device 42 generates pulse width modulated (PWM) signals for lighting device 46 over a communications line 44.

Communications line 44 may be a wire harness, a discrete wire, and the like. It is recognized, however, that the present invention contemplates the use of wireless communications, wherein signals generated by control device 42 are wirelessly transmitted to devices such as lighting device 46. In either the wired or wireless embodiment, control device 42 may generate a plurality of PWM signals for a plurality of lighting devices (e.g., lighting device 46 through lighting device N).

In the illustrated embodiment, lighting device 46 may be a light emitting diode (LED). Particularly, device 46 may be a tri-color LED containing multiple LEDs, including a LED 46a (e.g., a red LED), a LED 46b (e.g., a blue LED), and a LED 46c (e.g., a green LED). As recognized by one of ordinary skill in the art, the electrical system 32 may be grounded at a ground connection 48.

The ability to emit light having varying colors occurs by energizing LEDs 46a, 46b, and 46c. In one embodiment, the PWM signals generated by control device 42 for each LED 42a, 42b and 42c may have different PWM frequencies. For example, emitting light having a white color may be accomplished by generating PWM signals having the same frequency and duty cycle for each LED 46a, 46b, and 46c. As another example, to enable to emission of yellow light by lighting device 46, control device 42 may generate PWM signals having the same frequency and duty cycle for LED 46a (red LED) and LED 46c (green LED). As recognized by one of ordinary skill in the art, the creation of varying colors may be accomplished by mixing the various LED colors in accordance with the Commission International d'Eclairage (CIE) standard, which characterizes color by a luminance parameter and color coordinates.

Variations in light intensity are a function of the duty cycle of the PWM signals received by LEDs 46a, 46b, and 46c. Particularly, the longer the LEDs are energized, the greater the lighting intensity. To provide a desired color with a desired intensity, control device 42 may generate PWM signals for each LED (LEDs 46a, 46b, and 46c) having a particular energization period (or duty cycle). For example, LED 46a may be energized for a first energization period while LED 46b is energized for a second energization period. Accordingly, LED 46c may be energized for a third energization period. The energization periods may occur at the same or different times. Furthermore, the energization periods are adjustable and may be modified through the use of a selection device.

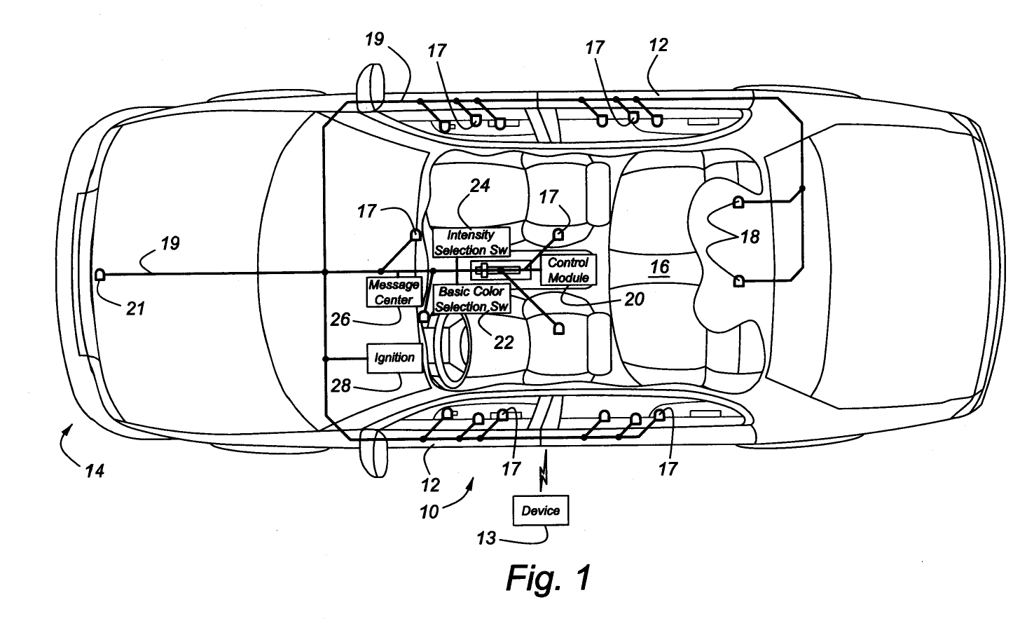

Now, referring to FIG. 1, an embodiment of the lighting system is illustrated being implemented on a vehicle 10. Vehicle 10 includes doors 12, an exterior portion 14, and an interior portion 16. Vehicle 10 may communicate with a device 13, which may be a key fob adapted to lock and unlock doors 12 and/or start an engine (not shown) of vehicle 10.

Vehicle 10 also includes a plurality of lighting devices 17, 18, and 21. Lighting devices 17, 18 and 21 are positioned and configured to illuminate exterior portions 14 and interior portions 16 of vehicle 10. Lighting devices 17, 18 and 21 may be light emitting diodes or virtually any type of device configured to emit light when energized. As such, the lighting devices may be lights for a map pocket within the vehicle, a pull handle, a foot well area and/or for a door trim. In one embodiment, the lighting device may be a lighting strip that is attachable to the vehicle door. Lighting device(s) 18 may be located on a roof of the vehicle to illuminate the roof or roof racks if present. Additionally, lighting device 21 may illuminate a name plate or badge of vehicle 10.

As shown, lighting devices 17, 18 and 21 are coupled to other electrical devices via a communications line 19. Communications line 19 may be a wire harness, a discrete electrical conductor or virtually any connecting device to allows current flow. It is recognized, however, that communications between devices may occur via a wireless protocol without departing from the scope of the present invention. In such an embodiment communications line 19 may not be required.

In the illustrated embodiment, control module 20 communicates with lighting devices 17, 18 and 21 via communications line 19. Control module 20 also communicates with other devices, including an ignition 28, a message center 26, and selection devices 22 and 24. As described above, a user may customize the manner in which light is provided via selection devices such as selection devices 22 and 24. In one embodiment, selection devices 22 and 24 may be contact switches that allow the user to physically adjust the color and intensity of emitted light. Alternatively, selection devices 22 and/or 24 may be embodied as an electronic switch that receives electrical inputs from other vehicle devices so as to vary the color and/or intensity of emitted light. In one aspect, selection device 22 may be a color selection switch while selection device 24 may be an intensity selection switch. In some embodiments, message center 26 may serve as a device for providing information to the user. In some embodiments, message center 26 may include a touch-screen that displays soft buttons for programming the lighting system.

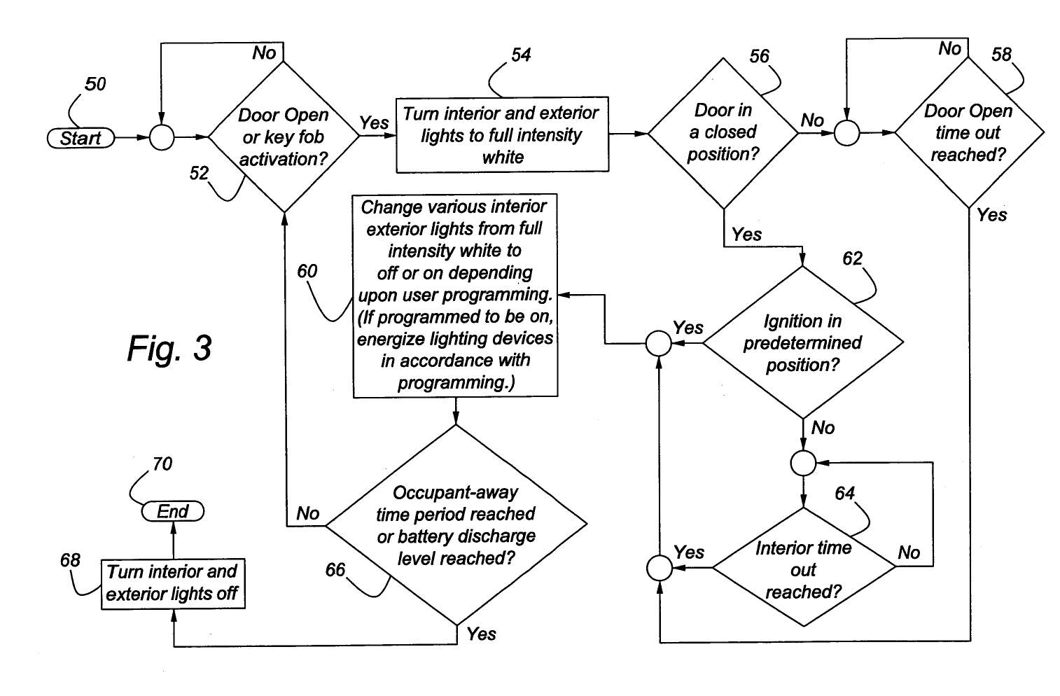

As described above, the lighting system may be configured to provide lighting having varying colors and intensities based upon various inputs and programming. FIG. 3 illustrates a method of providing light based on certain vehicle inputs and customer programming.

Referring to FIG. 3, block 50 is the entry point into the method. At block 52, the method includes determining whether a vehicle door is open or key fob activation signals have been received. If not, the method returns to block 50. If so, a block 54 occurs wherein interior and exterior lights are energized to emit light at full intensity. In one embodiment, the light emitted at block 54 may be white light. However, through the use of selection devices 22 and 24 or the message center 26 (FIG. 1), the color and intensity of the emitted light may be modified.

At block 56, the method determines whether the door has been placed in a closed position. If not, a block 58 occurs wherein the method determines whether a door-open time out has been reached. The door-open time out may be programmed into the control module to indicate when the vehicle doors have been open beyond a desirable time period when vehicle lighting devices are energized. If the answer to block 58 is no, the method returns to block 56. If the door open time out has been reached, a block 60 occurs.

At block 60, the method includes changing various interior/exterior lights from full intensity white to either off or on, depending upon user programming. If the user has programmed the system to be on, then the lighting devices would be illuminated having the pre-selected intensity and color. Following block 60, the method includes determining whether a predetermined occupant-away time period has elapsed or a battery discharge level has been reached. Block 66 enables the lighting system to conserve energy by minimizing the amount of power drawn from the battery. Although any time period may be implemented, the occupant-away time period may range up to eight hours. If the answer to block 66 is yes, a block 68 occurs wherein the interior and exterior lights are de-energized or turned off. Following block 68, the method terminates at block 70. Referring back to block 66, if the answer is no, the method returns to block 52.

Referring back to block 56, if the door is not in the closed position, a block 62 occurs. At block 62, the method determines whether the vehicle ignition is in a predetermined position (e.g., run, start, or accessory). If the vehicle ignition is in the predetermined position, a block 64 occurs, wherein the method determines whether an interior time out has been reached. The interior time out may be programmed into the control module and indicate a time period for when the interior lighting devices should be dimmed (lowered in intensity) and/or turned off. If the time out has not been reached, the method returns to block 62. If the interior time out has been reached, a block 60 occurs. Referring back to block 62, if the ignition is not in the predetermined position, a block 60 occurs. Following a block 60, the method continues as described in the foregoing.

While the best mode for carrying out the invention has been described in detail, those familiar with the art to which this invention relates will recognize various alternative designs and embodiments for practicing the invention as defined by the following claims.

What is claimed:

1. A lighting system for a vehicle, the system comprising:
at least one input;
at least one lighting device configured to emit light about at least one of interior and exterior portions of the vehicle when energized, wherein the emitted light has varying colors;
a control module receiving the one input and being communicative with the lighting device, the control module being configured to generate pulse width modulated (PWM) signals that energize the lighting device causing the lighting device to emit light having varying colors in response to the one input.

2. The system of claim 1, wherein the lighting device includes a tri-colored light emitting diode (LED) containing multiple LEDs including a red LED, a blue LED and a green LED, wherein the control module generates the PWM signals for individually energizing the red LED, the blue LED and the green LED thereby causing the lighting device to emit light having varying colors.

3. The system of claim 2, wherein the control module generates the PWM signals for the red LED at a first PWM frequency, the blue LED at a second PWM frequency and the green LED at a third PWM frequency, wherein the first PWM frequency, the second PWM frequency and the third PWM frequency control the color of the light emitted by the lighting device.

4. The system of claim 3, wherein the control module generates the PWM signals for the red LED for a first energization period, the blue LED for a second energization period and the green LED for a third energization period, wherein the length of the first, second and third energization periods are adjustable via the control module and cause the lighting device to emit light having varying colors at a predetermined intensity.

5. The system of claim 4, further comprising at least one selection device being communicative with the control module and being adapted to cause changes in the color and the intensity of the emitted light.

6. The system of claim 5, wherein the selection device is a contact switch configured to receive a physical input.

7. The system of claim 5, wherein the selection device is an electronic switch configured to receive an electrical input.

8. The system of claim 5, wherein the one input received by the control module includes at least one of a door input, an ignition input and a keyless entry device input.

9. A method of providing light about at least one of exterior and interior portions of a vehicle through the use of at least one lighting device, the method comprising:
receiving at least one input;
generating pulse width modulated (PWM) signals configured to cause the lighting device to emit light having varying colors in response to the at least one input; and
emitting light about at least one of the interior and exterior portions of the vehicle via the at least one lighting device, wherein the color of the emitted light varies based upon the at least one input.

10. The method of claim 9, wherein the lighting device includes a tri-colored light emitting diode (LED) containing multiple LEDs including a red LED, a blue LED and a green LED, wherein the control module generates the PWM signals for individually energizing the red LED, the blue LED and the green LED thereby causing the lighting device to emit light having varying colors.

11. The method of claim 10, wherein the control module generates the PWM signals for the red LED at a first PWM frequency, the blue LED at a second PWM frequency and the green LED at a third PWM frequency, wherein the first PWM frequency, the second PWM frequency and the third PWM frequency control the color of the light emitted by the lighting device.

12. The method of claim 11, wherein the control module generates the PWM signals for the red LED for a first energization period, the blue LED for a second energization period and the green LED for a third energization period, wherein the length of the first, second and third energization periods are adjustable via the control module and cause the lighting device to emit light having varying colors at a predetermined intensity.

13. The method of claim 12, further comprising:
receiving a signal from at least one selection device via the control module, wherein the signal causes changes in the color and the intensity of the emitted light.

14. The method of claim 13, wherein the selection device is a contact switch being configured to receive a physical input.

15. The method of claim 13, wherein the selection device is an electronic switch being configured to receive an electrical input.

16. The method of claim 9, wherein the one input received by the control module includes at least one of a door input, an ignition input and a keyless entry device input.

17. A lighting system for a vehicle having a control module, at least one door and an ignition, the system comprising:
a selection device in communication with the control module for programming the control module;
at least one lighting device configured to emit light about at least one of interior and exterior portions of the vehicle when energized, wherein the emitted light has varying colors and intensities; and
wherein the control module is configured to:
receive inputs from the door and the ignition, and
generate pulse width modulated (PWM) signals that energize the lighting device causing the lighting device to emit light having varying colors and intensities based on the programming by the selection device and inputs from the door and the ignition.

18. The system of claim 17, wherein the lighting device includes a tri-colored light emitting diode (LED) containing multiple LEDs including a red LED, a blue LED and a green LED, wherein the control module generates the PWM signals based on the programming and inputs from the door and the ignition for individually energizing the red LED, the blue LED and the green LED thereby causing the lighting device to emit light having varying colors.

19. The system of claim 18, wherein the control module generates the PWM signals for the red LED at a first PWM frequency, the blue LED at a second PWM frequency and the green LED at a third PWM frequency, wherein the first PWM frequency, the second PWM frequency and the third PWM frequency control the color of the light emitted by the lighting device.

20. The system of claim 19, wherein the control module generates the PWM signals for the red LED for a first energization period, the blue LED for a second energization period and the green LED for a third energization period, wherein the length of the first, second and third energization periods are adjustable via the selection device and the control module and cause the lighting device to emit light having varying colors and intensities.
